(19) United States
(12) Patent Application Publication
(10) Pub. No.: US 2026/0256180 A1
(43) Pub. Date: Sep. 3, 2026

(54) Food coating device and method

(71) Applicant: Esteban Daniel Gonzalez, Reno, NV (US)

(72) Inventor: Esteban Daniel Gonzalez, Reno, NV (US)

(21) Appl. No.: 19/067,937

(22) Filed: Mar. 2, 2025

(51) Int. Cl. A23P 20/12; B65G 15/50

(52) U.S. Cl. CPC A23P 20/12; B65G 15/50

(57) ABSTRACT

A food coating device is provided, comprising a permeable conveyor, a powdered material supply unit, and an air supply unit. The permeable conveyor transports a plurality of food pieces. The powdered material supply unit deposits a powdered material onto the plurality of food pieces. The air supply unit directs a stream of air towards the plurality of food pieces.

### BACKGROUND

Food products are often coated with a powdered material. For example, potato chips, tortilla chips and corn chips are regularly coated with salt, barbecue seasoning, or sour-cream-and-onion seasoning. As other examples, meat and fish are sometimes coated with flour or bread crumbs, and rice cakes with coconut sugar. This coating process generates waste. This waste can consist of food products that do not meet quality controls. For instance, tumbling the food products can break brittle food products such as potato chips. This waste can also consist of powdered material that does not coat the food products. For example, some of this powdered material can end up in the floor of the food processing plant. This is waste. Therefore, devices and methods to coat food products with powdered material that meet quality controls and reduce waste are desirable. This is because reducing food waste increases food security and conserve energy. However, technical challenges stand as barriers to advancements in the design of food coating devices and methods.

### SUMMARY

To address the problem discussed above, a food coating device and a method are provided.

According to one aspect of the present disclosure, the food coating device comprises a permeable conveyor for transporting the plurality of food pieces; a powdered material supply unit positioned directly above the permeable conveyor for depositing the powdered material onto the plurality of food pieces; and, an air supply unit for directing a stream of air towards the plurality of food pieces, the air supply unit comprising a duct, a flow conditioner positioned inside the duct, and a fan positioned upstream of the flow conditioner.

According to another aspect, the food coating device comprises a permeable conveyor; a powdered material supply unit positioned directly above the permeable conveyor; an air supply unit comprising a duct, a flow conditioner positioned inside the duct, and a fan positioned upstream of the flow conditioner; a particle detector; a light source; and, a control unit for controlling a speed of the fan using a signal from the particle detector.

### BRIEF DESCRIPTION OF DRAWINGS

FIG. 1A shows a schematic, perspective view of a food coating device according to an exemplary embodiment of the present disclosure.

FIG. 1B shows a close-up, perspective view of the powdered material supply unit of the food coating device of FIG. 1A.

FIGS. 2A and 2B show schematic, perspective views of the air supply unit according to an exemplary embodiment of the present disclosure.

FIGS. 3A, 3B, 3C, 3D, 3E, 3F, 3G, 3H, and 3I show CFD results showing computational particles of a powdered material.

FIGS. 4A and 4B show prophetic tables from CFD simulations.

FIG. 5 shows prophetic plots from CFD simulations indicating a velocity right downstream of the flow conditioner for different designs of the air supply unit.

FIG. 6A shows a preliminary air supply unit.

FIG. 6B shows another preliminary air supply unit.

FIG. 7 shows a schematic, perspective view of a food coating device according to an exemplary embodiment of the present disclosure.

FIGS. 8A and 8B show schematic, perspective views of a food coating device according to an exemplary embodiment of the present disclosure.

FIG. 9 shows a method to coat food pieces with the powdered material.

FIG. 10 shows a schematic view of a control unit of the embodiments in FIGS. 7, 8A or 8B.

### DETAILED DESCRIPTION

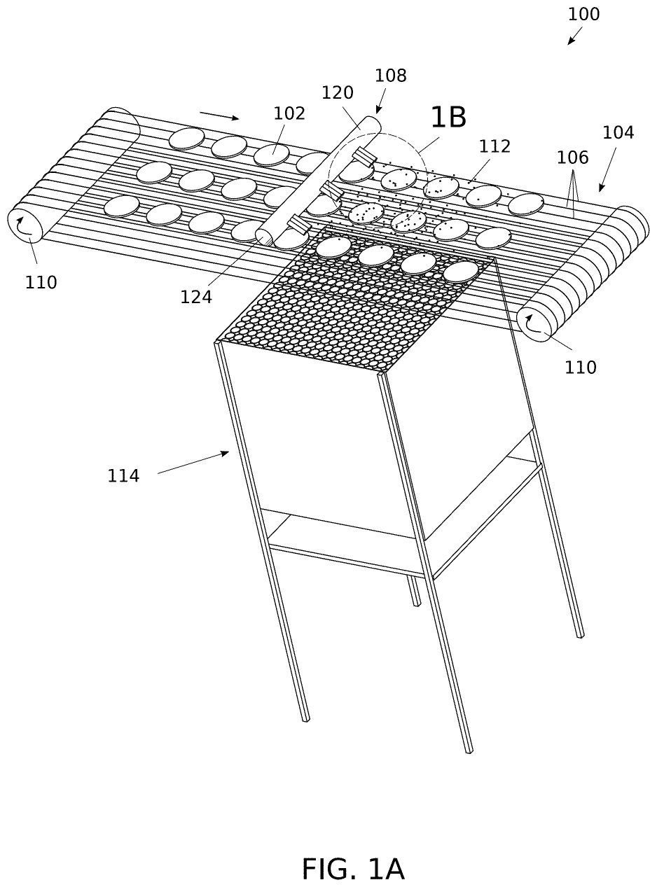

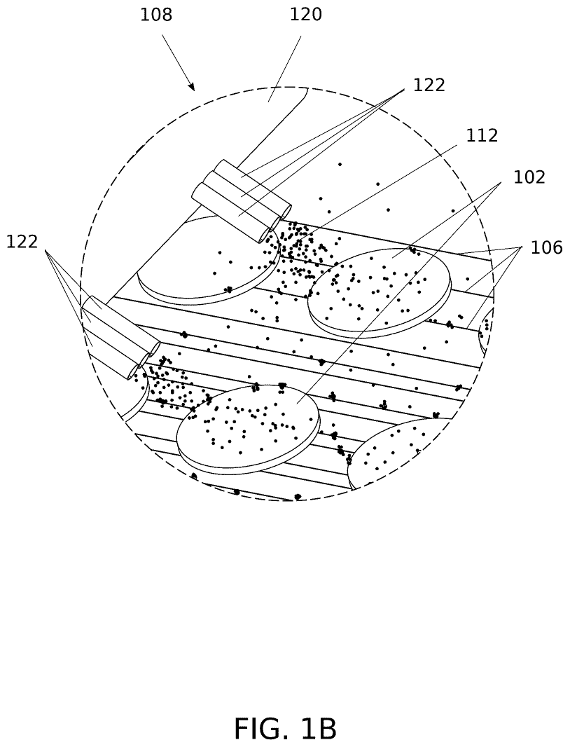

FIG. 1A shows a schematic, perspective view of a food coating device 100 according to an exemplary embodiment of the present disclosure. This food coating device 100 is made of the following components.

A permeable conveyor 104 transports a plurality of food pieces 102. The permeable conveyor 104 can be comprised of a plurality of cords 106. These cords 106 are adjacently spaced laterally to each other, as indicated in FIG. 1A. Instead of the plurality of cords 106, a plurality of chains can be used. The permeable conveyor could also consist of a band with perforations. It could also consist of a wire mesh, such as those from Yangzhou Leneng Machinery Co., Ltd (Yangzhou City, Jiangsu Province, China). The permeable conveyor 104 is made of a food-grade material. This conveyor is driven by a conveyor driven unit. This unit comprises conveyor rollers 110 and electric motors (not shown).

FIG. 1B shows a close-up, perspective view of a powdered material supply unit 108 that is positioned directly above the permeable conveyor 104 of the food coating device 100 of FIG. 1A. The powdered material supply unit 108 is part of a pneumatic-dense-phase-transport system (not shown). Examples of these systems are those from VAC-U-MAX Aerocon (69 William Street, Belleville, NJ). This supply unit 108 in FIG. 1B consists of a large tube 120 connected to a plurality of small tubes 122. The supply unit 108 is connected through the inlet 124 (see FIG. 1A) to the pneumatic-dense-phase-transport system. This connection could be done with a hose made of food-grade material. As another example, the powdered material supply unit could be part of an aero-mechanical conveying system, such as those from VAC-U-MAX Aerocon (69 William Street, Belleville, NJ). As another example, the powdered material supply unit could be a vibratory feeder. This could consist of a conveying tube, channel or trough, and a device to vibrate the channel or trough. This vibratory feeder could also consist of a box with perforated holes and a device to vibrate the box. Another example of the supply unit is a screw conveyor system.

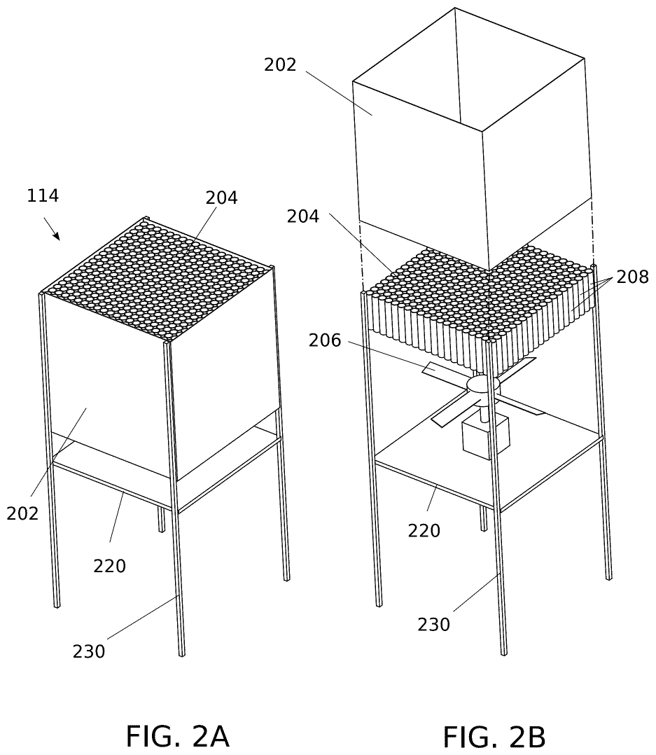

FIGS. 2A and 2B show schematic, perspective views of the air supply unit 114 according to an exemplary embodiment of the present disclosure. The air supply unit 114 comprises a duct 202, a flow conditioner 204, a fan 206, a fan base 220, and a plurality of supports 230.

The duct 202 can consist of a single duct, as in FIGS. 2A and 2B, or a series of duct segments joint together. Different shapes of duct can be used. In FIGS. 2A and 2B, a rectangular duct is used. The duct is typically made of sheet of some material, metal for example. When using a series of duct segments joint together, joints can be made by using brackets, or by welding.

A flow conditioner 204 is positioned inside the duct 202. In FIGS. 2A and 2B, the flow conditioner 204 consists of a plurality tubes 208 that are parallel to each other. The centerline of the tubes 208 is parallel to the air stream directed towards the food pieces 102. The tubes 208 are arranged to form a honeycomb structure. The tubes 208 in FIGS. 2A and 2B have a circular shape. Other shapes can be used, such as hexagonal. The tubes 208 can be made of metal or plastic. In FIGS. 2A and 2B, the tubes 208 have a diameter of 20 mm. This is provided as an example, other dimensions can be used. Other types of flow conditioners can be used. For instance, the plurality of tubes could be replaced with a plate with a plurality of perforated holes.

The fan 206 is positioned upstream of the flow conditioner 204. In the arrangement of FIG. 2B, this means that the fan 206 is below the flow conditioner 204. In FIG. 2B, the fan 206 is an axial fan. Centrifugal fans could also be used. In FIG. 2B, the fan 206 sits on a fan base 220.

The food coating device 100 in FIG. 1A is operated as follows.

The device 100 in FIG. 1A is installed in a food processing plant. For instance, it could be installed in a control room (not shown in FIG. 1A) in the food processing plant. In this control room, pressure, temperature, and humidity are controlled to some values. For example, the pressure of the control room can be less than the pressure of the rest of the food processing plant. This prevents small particles from spreading around. As another example, temperature and humidity can be set to values that reduce the agglomeration of the powdered material 112.

Food pieces 102 are sent towards the food coating device 100 through a feeding conveyor (not shown in FIG. 1A). Examples of food pieces 102 include potato chips, tortilla chips, corn chips, rice cakes, flour cakes, meat, fish, and poultry, among others. Thereafter the food pieces 102 go into the permeable conveyor 104 of the food coating device 100. This transfer should be smooth, to not damage the food pieces. The food pieces 102 can be cooked or not before approaching the food coating device 100. Potato or tortilla chips, for instance, are typically cooked before approaching the food coating device 100.

While the food pieces 102 are transported in the permeable conveyor 104, the powdered material supply unit 108 coats the food pieces 102 with the powdered material 112. The powdered material 112 can be salt, seasoning, wheat flour, rice flour, sugar, bread crumbs, cocoa powder, and ground sesame, among others. Examples of seasoning include barbecue seasoning, or sour-cream-and-onion seasoning.

In FIGS. 1A and 1B, powdered material 112 and air are supplied by a pneumatic-dense-phase-transport system (not shown). Then the powdered material 112 and air enter the large tube 120 of the powdered material supply unit 108 through the inlet 124. Then they go into the small tubes 122, and then exit the small tubes 122. Finally, the powdered material 112 falls, aided by gravity, towards the food pieces 102.

A fraction of the powdered material 112 coats the food pieces 102. Another fraction falls via gravity through the permeable conveyor 104, towards the air supply unit 114. This fraction encounters a stream of air that is directed towards the food pieces 102 by the air supply unit 114. In FIG. 1A, this stream of air is directed upwards (against gravity). As a result, particles forming the powdered material 112 get re-suspended, form a particle cloud, and coat the food pieces 102.

The stream of air is generated by the fan 206 in FIG. 2B. This fan 206 is rotated typically with an electric motor. The speed of the stream of air generated by the fan 206 can be controlled by controlling the rotational speed of the fan, or fan speed. In turn, this fan speed can be controlled by controlling the power, or voltage, or current applied to the fan.

Inside the air supply unit 114 shown in FIGS. 2A and 2B, the flow conditioner 204 reduces the intensity of recirculation regions or vortices in the flow. To accomplish this, it is preferable for the hydraulic diameters of the tubes 208 of the flow conditioner 204 to produce a laminar flow, or a weakly-turbulent flow. To do this, the parameter (U D)/nu should be less than about 10000. Here U is the speed of the air stream inside the tubes, D is the tube hydraulic diameter, and nu is the kinematic viscosity of the air.

In the following, the operation of the food coating device 100 in FIG. 1A is further explained using results from computational fluid dynamic (CFD) simulations.

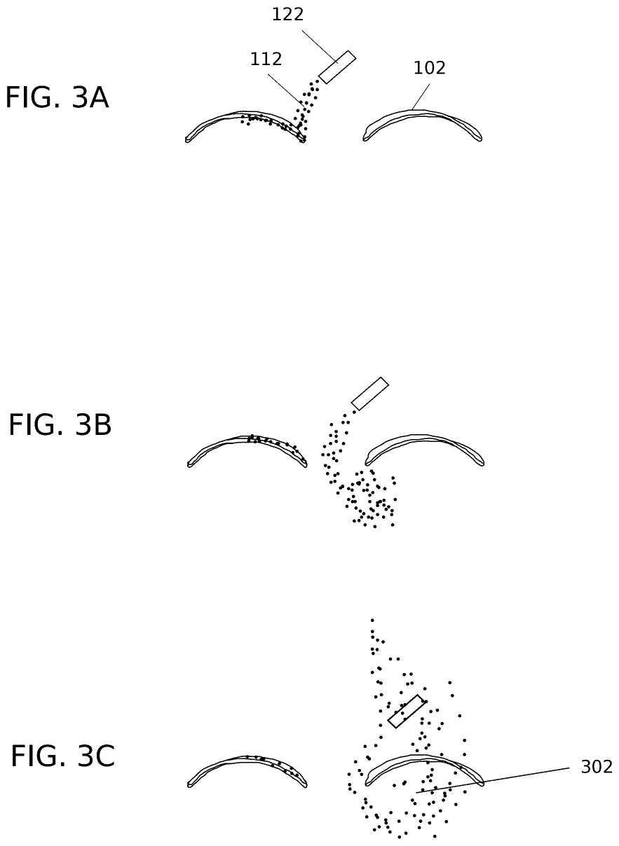

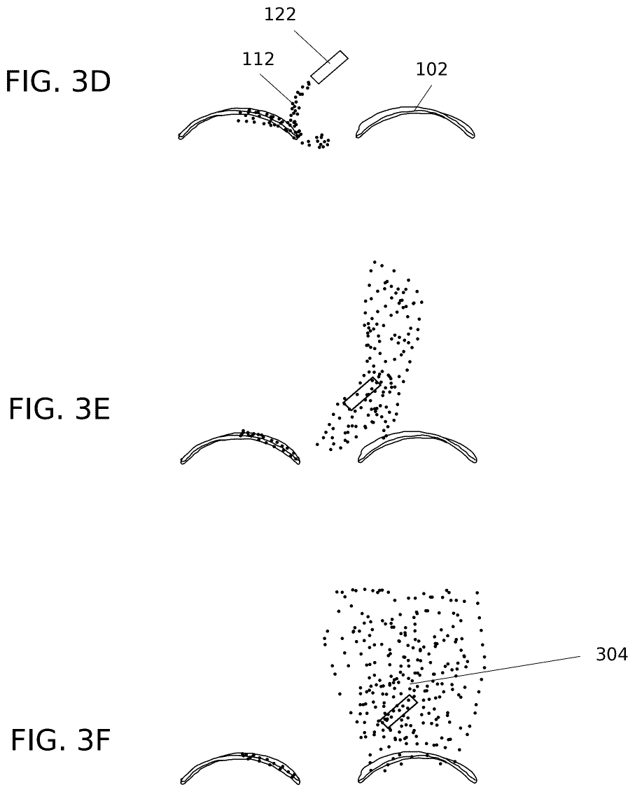

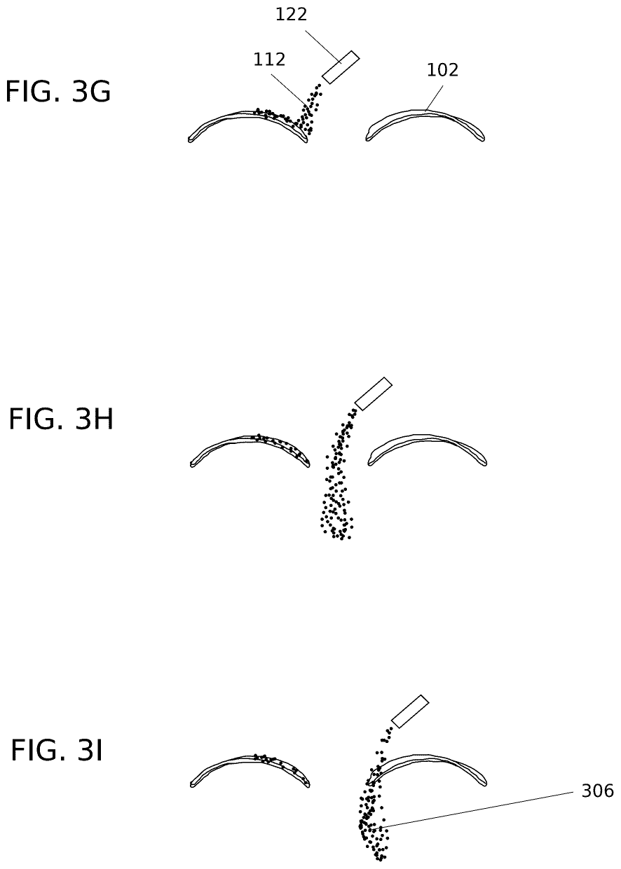

FIGS. 3A, 3B and 3C show CFD results showing computational particles of a powdered material 112 at three different times. (Computational particles or parcels are mathematical representations of a group of physical or actual particles.) For this example, the food pieces 102 are potato chips with a saddle shape. They move horizontally in a conveyor (not shown in FIGS. 3A, 3B and 3C) at 0.26 m/s. The powdered material 112 consists of particles with 100 micron diameter. Air flows vertically upward (against gravity) at 1 m/s. This speed can be controlled with the fan 206. These conditions are representative of those used in the manufacturing of potato chips. For instance, in the case of seasoning, typical particle diameters are 30-300 microns. This example is used for explanation purposes and does not limit the application of the food coating device 100 in FIG. 1A.

The CFD simulation solves a set of equations governing the fluid (air) flow, a set of equations governing the motion of the particles, and a set of equations governing the interaction between fluid and particles. In the CFD simulation, the movement of the food pieces 102 in a conveyor is not simulated exactly as in the actual case, but it is emulated as follows. The computational domain is a box. The food pieces 102 are inside this box and they are stationary. A horizontal air velocity depending on the conveyor velocity is set. The powdered material supply unit moves with a velocity depending on the conveyor velocity.

In FIGS. 3A, 3B, and 3C, the particles forming the powdered material 112 fall from the small tubes 122 of the powdered material supply unit 108 towards the food pieces 102. As the particles fall, a fraction of the particles fall onto the food pieces 102, coating them. Another fraction falls between the food pieces 102 and towards the bottom, towards the air supply unit (not shown in FIGS. 3A, 3B and 3C). Without the stream of air from the air supply unit 114, this fraction of particles falling between the food pieces 102 is wasted. But when using the air supply unit 114, this fraction of particles meets an oncoming stream of air. The resulting flowfield is complex since it involves interactions between the stream of air, the food pieces 102, and the particles. As a result, as can be seen in FIGS. 3A, 3B, and 3C, the fraction of particles falling between the food pieces 102 gets re-suspended, forming a particle cloud. This reduces waste.

FIGS. 3D, 3E and 3F are similar to FIGS. 3A, 3B, and 3C (respectively) but for a vertical velocity magnitude of 2 m/s instead of 1 m/s. In FIGS. 3D, 3E, and 3F, too many particles are blown away (upwards) from the food pieces 102. This would constitute waste.

FIGS. 3G, 3H and 3I are similar to FIGS. 3A, 3B, and 3C (respectively) but for a particle size of 200 micron instead of 100 micron. Notice in FIGS. 3G, 3H and 3I that most of the particles falling between the food pieces 102 are not re-suspended as in FIGS. 3A, 3B, and 3C but move downward towards the air supply unit 114. This is waste.

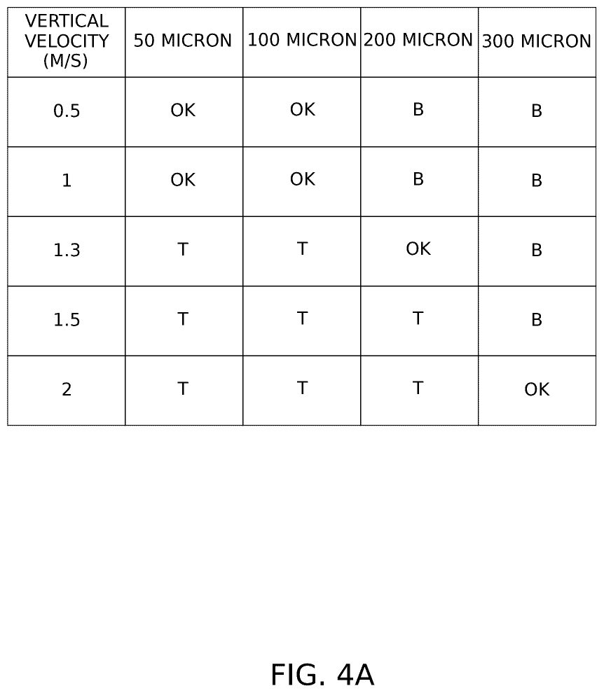

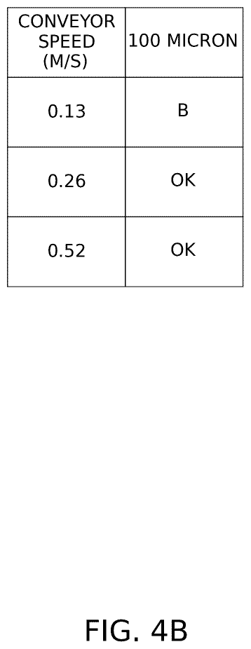

FIGS. 4A and 4B show prophetic tables from CFD simulations. In FIGS. 4A and 4B, OK denotes an acceptable outcome (for example FIGS. 3A, 3B, and 3C); T denotes an unacceptable outcome where too many particles forming the powdered material 112 are blown away from the food pieces 102 (for example FIGS. 3D, 3E and 3F); and B denotes an unacceptable outcome in which too many particles fall between the food pieces 102 and move towards the air supply unit 114 (for example FIGS. 3G, 3H and 3I). FIG. 4A shows these outcomes as functions of the vertical velocity magnitude and particle size for a conveyor speed of 0.26 m/s. FIG. 4B shows these outcomes as functions of conveyor speed for a particle size of 100 microns and a vertical velocity of 1 m/s. The particle size can be quantified, for instance, with an average or a median of the particle size distribution of the powdered material 112.

FIGS. 4A and 4B indicate that, for a given particle size, a combination of vertical velocity (which can be controlled with the fan 206) and conveyor speed (which can also be controlled) can produce an acceptable outcome. This result can help reduce waste when coating food pieces because it shows which parameters can produce an acceptable outcome. This result is complex and non-trivial.

Consider the result in FIG. 4A for 100-micron particles and a vertical velocity of 1 m/s. FIG. 4A suggests that this is acceptable. This situation is that in FIGS. 3A, 3B, and 3C. Now say that the vertical velocity is 1 m/s in some regions and 2 m/s in other regions. This situation could result from strong recirculation regions or vortices. FIG. 4A suggests that this situation with vertical velocities of 2 m/s is unacceptable: Particles will get blown away as in FIGS. 3D, 3E and 3F. Therefore, it is desirable to have vertical velocities that are uniform in space. By the same token, it is also desirable to have vertical velocities that are uniform in time. To achieve this uniformity, the air supply unit 114 in FIGS. 2A and 2B includes a flow conditioner 204. But there is something else needed, as explained next.

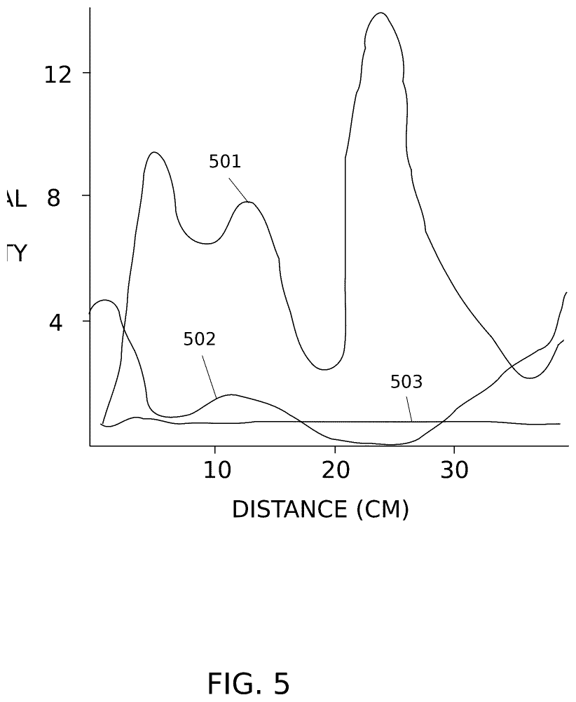

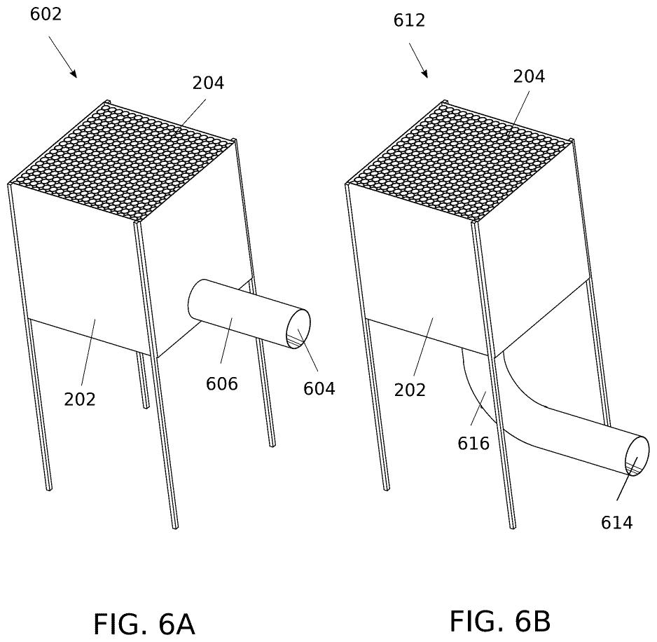

FIG. 5 shows prophetic plots from CFD simulations for different designs of the air supply unit and the same volumetric flowrate. In FIG. 5, the curves 501, 502, and 503 represent vertical velocity magnitude as a function of distance along a line. This line is taken between two points on a plane right downstream of the flow conditioner 204. The normal of this plane is directed upwards. In FIG. 5, the curve 503 is for the air supply unit in FIGS. 2A and 2B, the curve 502 is for the preliminary air supply unit in FIG. 6A, and the curve 501 is for another preliminary air supply unit shown in FIG. 6B.

FIG. 6A shows a preliminary air supply unit 602. This unit has a straight inlet tube 606 with an inlet section 604. It also has a flow conditioner 204. A fan (not shown in FIG. 6A) is positioned upstream of the inlet section 604. This fan generates a stream of air. The stream of air enters the air supply unit 602 through the inlet section 604, then goes through the tube 606, then enters the duct 202, then goes through the flow conditioner 204, and then exits the flow conditioner 204. In this way, the stream of air is directed towards the food pieces.

FIG. 6B shows another preliminary air supply unit 612. This unit 612 is similar to the unit 602 in FIG. 6A but it has a curved inlet tube 616 with an inlet section 614.

Going back to FIG. 5, the curve 503 for the air supply unit in FIGS. 2A and 2B shows a small variation of velocity with distance. In contrast, curves 502 and 501 for the preliminary air supply units in FIGS. 6A and 6B, respectively, show large variations of velocity with distance, in particular curve 501 for the preliminary air supply unit in FIG. 6B. Now, recall from the above discussion that it is desirable to have vertical velocities that are nearly uniform in space. In other words, velocities should vary little along a distance of some representative line of measurement. Therefore, the air supply unit in FIGS. 2A and 2B is an enhancement over the preliminary air supply units in FIGS. 6A and 6B. This enhancement is achieved by having the fan 206 in FIG. 2B generate a vertical stream of air directed towards the food pieces 102. This prevents flow-direction changes that would produce strong recirculation regions, as happens with the preliminary air supply units in FIGS. 6A and 6B.

FIGS. 4A and 4B show that an acceptable outcome is feasible for a particular combination of particle size, vertical velocity and conveyor speed. Other parameters could be included, such as the standard deviation of the size of the particles forming the powdered material 112. Therefore, an operator of the coating device 100 in FIG. 1A could conduct experiments to generate tables such as those in FIGS. 4A and 4B during a test trial, before production. For this purpose, the operator would need to visually inspect the particle cloud and measure the speed of the stream of air (or an equivalent metric) and conveyor speed (or an equivalent metric), and perhaps other metrics. This visual inspection could be conducted with, say, a digital camera. Once this is done, the operator would know how to operate the coating device 100 in FIG. 1A to achieve acceptable outcomes when using the device 100 in production. However, for an automated way to use the coating device, the following embodiments and/or method could be used.

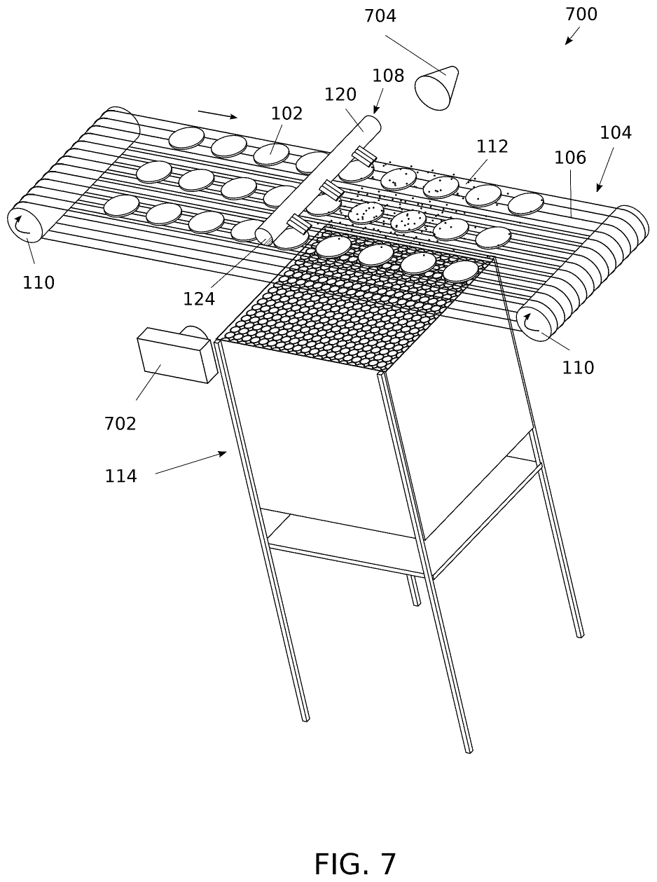

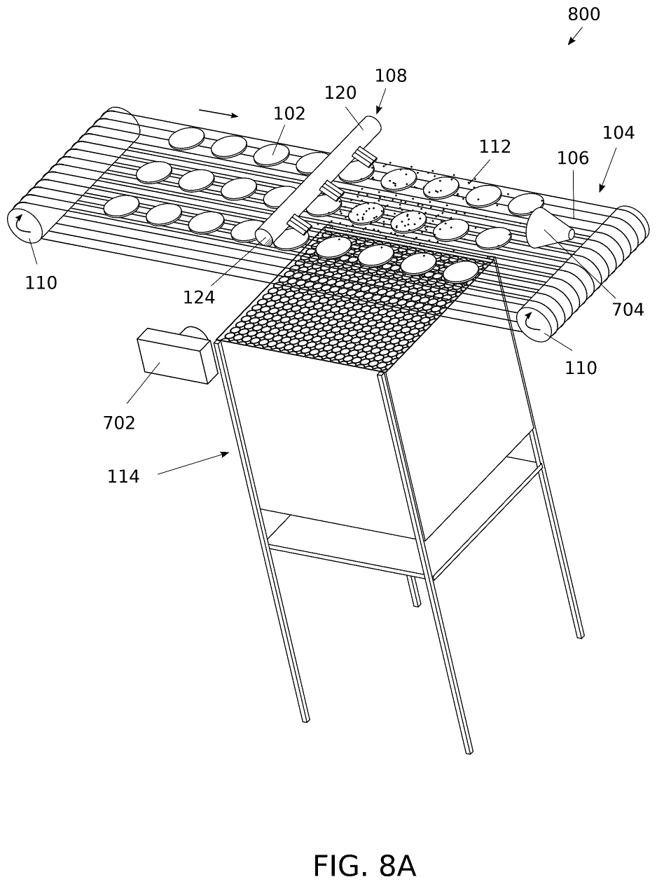

FIG. 7 shows a schematic, perspective view of a food coating device 700 according to an exemplary embodiment of the present disclosure. This is similar to the embodiment of FIG. 1A but further comprising a particle detector 702, a light source 704, a control unit (not shown and discussed later), and supports for the particle detector 702 and light source 704 (not shown). Examples of a light source 704 include light-emitting diodes (LEDs), incandescent bulbs, and lasers. Examples of a particle detector include a camera (digital or not), a camera with a set of optics, and an array of photodiodes. In FIG. 7 the particle detector 702 is a camera. Other detectors could be used. Furthermore, more than one detector or more than one light source could be used. A simple light source such as LEDs and a digital camera are sufficient. The light source or particle detector could be inside transparent casings (not shown) to protect them from the particle-laden environment.

With the embodiment in FIG. 7, a particle cloud, such as those in FIGS. 3A, 3B, 3C, 3D, 3E, 3F, 3G, 3H, and 3I for example, could be detected with a particle imaging technique. An example of a particle imaging technique is shadowgraphy. With shadowgraphy, a light source 704 and a particle detector 702, such as a digital camera, are positioned approximately in front of each other, as in FIG. 7 for example. In other words, the light of the light source 704 is aimed towards the particle detector 702. The light travels from the light source 704, through the particle cloud forming the powdered material 112, and towards the particle detector 702, making a shadow on the light sensing elements of the particle detector 702. An image can be made from this shadow. This image is a pixelated image in the case of a digital camera. In this way, imaging techniques such as shadowgraphy provide information about the particles. Examples of this information include estimates of the amount of particles, particle sizes, and particle velocities.

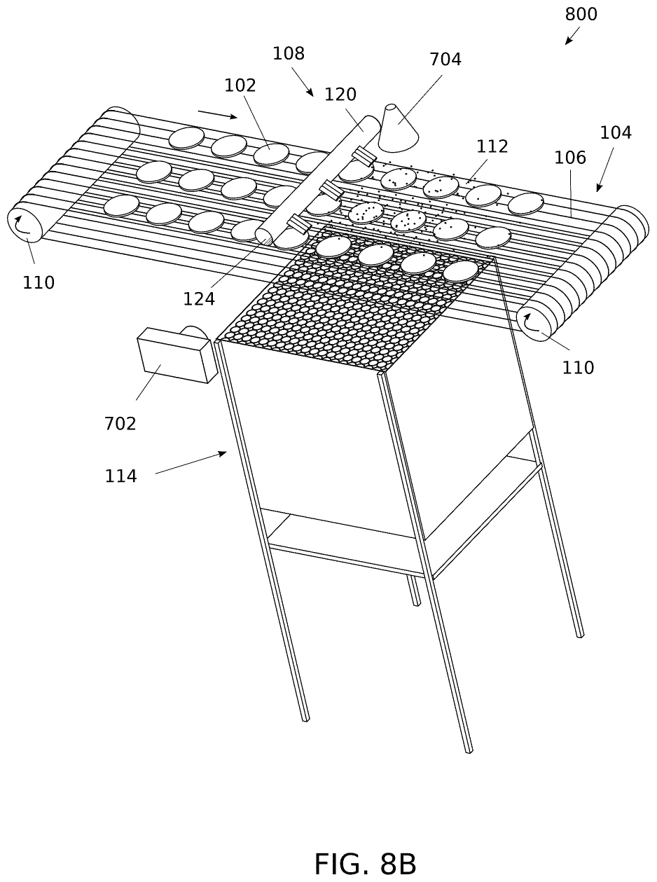

FIGS. 8A and 8B show schematic, perspective views of a food coating device 800 according to an exemplary embodiment of the present disclosure. This is similar to the embodiment of FIG. 1A but further comprising a particle detector 702, a light source 704, a control unit (not shown and discussed later), and supports for the particle detector 702 and light source 704 (not shown).

FIGS. 8A and 8B are similar to FIG. 7 but position the particle detector 702 and light source 704 in a different way. In FIGS. 8A and 8B, unlike FIG. 7, the light source 704 and the particle detector 702 are not positioned in front of each other but at an angle. In particular, in FIGS. 8A and 8B the light of the the light source 704 is not aimed directly towards the particle detector 702, as in FIG. 7. In FIG. 8A the powdered material 112 is illuminated by the light source 704 from the right. And in FIG. 8B the powdered material 112 is illuminated by the light source 704 from the top. Other similar arrangements can be used. This is done to use an imaging technique called scattering. With scattering, the light travels from the light source 704, gets to the particles forming the powdered material 112, the particles scatter this light, and then the scattered light travels to the particle detector 702.

As explained so far, the food coating device 700 in FIG. 7 is designed to use shadowgraphy. And the food coating device 800 in FIGS. 8A and 8B is designed to use scattering. With either imaging technique, a light from the light source 704 is directed towards the powdered material 112 so that a fraction of the light reaches the particle detector 702, and another fraction does not.

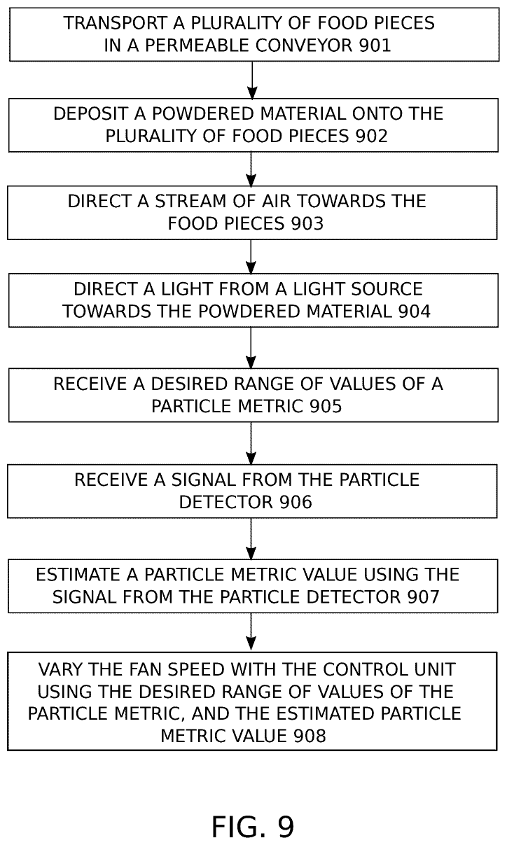

FIG. 9 shows a method to coat food pieces 102 with the powdered material 112 comprising the following steps.

First, at step 901, transport the plurality of food pieces 102 in the permeable conveyor 104.

Second, at step 902, deposit the powdered material 112 onto the plurality of food pieces 102 with the powdered material supply unit 108.

Third, at step 903, direct the stream of air towards the food pieces 102 with the air supply unit 114.

Fourth, at step 904, direct the light from the light source 704 towards the powdered material 112 so that a fraction of the light reaches the particle detector 702.

These first, second, third, and fourth steps are discussed above.

Fifth, at step 905, receive a desired range of values of a particle metric. This step is explained shortly.

Sixth, at step 906, receive a signal from the particle detector 702. This signal depends on the type of particle detector and imaging technique. For example, when using a digital camera and shadowgraphy, or when using a digital camera and scattering, this signal could be a pixelated image. As another example, when using an array of photodiodes as the particle detector the signal is a set of values of light intensity.

Seventh, at step 907, estimate a particle metric value using the signal from the particle detector 702.

For example, when detecting a pixelated image, a particle metric could be the sum S of the intensity of all the pixels in the image Ij minus the intensity of the pixels of a background image Bj: S=sum(abs(Ij−Bj)). Here the summation sum( ) is conducted over the index j denoting the pixels. The symbol abs( ) means absolute value of whatever is inside the parenthesis. In shadowgraphy, abs(Ij−Bj) could be made to correspond to the intensity of the shadow. In scattering, abs(Ij−Bj) could be made to correspond to the intensity of the scattered light. In either case, large values of abs(Ij−Bj) indicate the presence of particles. S can be defined in a similar way when using an array of photodiodes. But in this case j does not denote pixels, but j is an index corresponding to each photodiode.

The intensity of the pixels of a background image Bj is obtained by operating the food coating device 700 or 800 with no particles present. In shadowgraphy for example, the subtraction of the background Bj takes into account the fact that other components of the coating device make a shadow, notably the conveyor 102, the food pieces 102, and the powdered material supply unit 108. A similar background subtraction could be needed in scattering.

Another example of a particle metric is the center of mass CM of the image Ij minus the intensity of the pixels of a background image Bj: CM=sum(abs(Ij−Bj)xj)/S, where xj is the position of the pixel j. CM gives an approximate location of the particle cloud. CM is also called the centroid of the image. Another example is a dispersion metric D=sum(abs(Ij−Bj)abs(xj−CM))/S. D gives an indication of how big the particle cloud is. Other metrics could be used. In addition, a particle metric could be a combination of other metrics. For instance, a metric M could be defined as M=W1 CM+W2 D where W1 and W2 are weighting functions.

Having explained the particle metric, the desired range of values of the particle metric can be clarified. This is done with some examples. Consider the center of mass CM. Recall that FIGS. 3A, 3B, 3C, 3D, 3E, 3F, 3G, 3H, and 3I show acceptable and unacceptable outcomes. Take FIG. 3C. In this case, the CM 302 is near the food pieces 102. (To be precise, the CM is approximately at the endpoint of the lead line of 302.) In contrast, in FIG. 3F the CM 304 is way above the food pieces 102. And in FIG. 3I the CM 306 is way below the food pieces 102. Therefore, the vertical position of CM can be used to assess acceptable or unacceptable outcomes. As a result, when using CM in this way, a desired (acceptable) range of values of the particle metric are those near the food pieces 102.

To show another example of the desired range of values of the particle metric, consider the sum S and FIG. 3C. Say shadowgraphy is used. The situation in FIG. 3C is acceptable, as explained above. Say that in this case S has a value S1. S1 is large because many particles are detected by the particle detector 702, and these produce a strong shadow. Now say all particles are blown away because of a strong air speed generated with the fan. This is unacceptable. Say that in this case S has a value of S2. S2 is small because not many particles are detected by the particle detector 702, and this produces a weak shadow, or no shadow at all. Therefore, S1>S2. In this way, S can be used to assess acceptable and unacceptable outcomes, and determine a desired range of values for the particle metric.

In practice, determining the desired range of values of the particle metric would be conducted during a test trial, before production. This can be done with a series of experiments. For instance, these experiments could gather results such as those in FIGS. 4A and 4B but empirically, not with CFD simulations. Nevertheless, CFD simulations can be used to complement and augment the empirical data.

Eight, at step 908, vary the rotational speed of the fan 206 (or fan speed) with the control unit using the desired range of values of the particle metric, and the estimated particle metric value using the signal from the particle detector. The variation of the speed of the fan is conducted through a variation of, for instance, the power, current, or voltage delivered to the fan.

To explain this eight step, consider the following examples. Say the fan speed is very low and the signal from the particle detector indicates that particles simply fall via gravity, as in FIGS. 3G, 3H and 3I for instance. In this case, the control unit increases the fan speed. Now say the fan speed is very high and the signal from the particle detector indicates that the particles are blown away from the food pieces, as in FIGS. 3D, 3E and 3F for example. In this situation, the control unit decreases the fan speed. As a last example, say that the fan speed is such that the estimated particle metric is within the desired range of values of the particle metric. In other words, the situation is that in FIGS. 3A, 3B, and 3C. In this case, the fan speed is not varied. In this way, this method attempts to maintain a suspension of particles, as for example in FIGS. 3A, 3B, and 3C. This is accomplished by maintaining the measured particle metric value within the desired particle metric values.

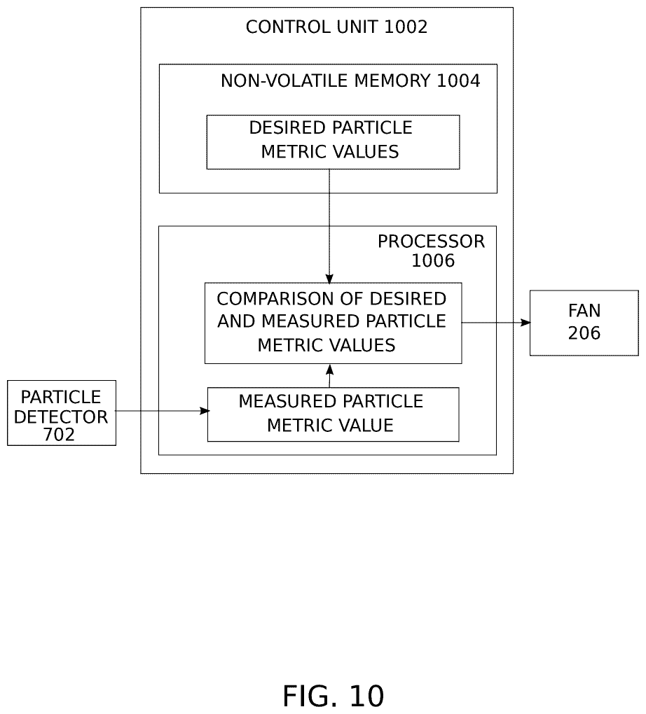

FIG. 10 shows a schematic view of a control unit 1002 of the embodiments in FIGS. 7, 8A or 8B when using the method in FIG. 9. The control unit 1002 comprises a processor 1006, a volatile memory (not shown), and a non-volatile memory 1004. The desired range of values of the particle metric are stored in the non-volatile memory 1004. The particle metric could be S, CM, or D discussed above. The control unit 1002 receives the signal from the particle detector 702. This signal could be a pixelated image. The processor 1006 of the control unit 1002 takes this signal and calculates a measured particle metric value. Thereafter, the processor 1006 compares the desired particle metric with the measured particle metric. From this comparison, the processor calculates a signal to be sent to the fan. In this way, the processor controls the fan speed to maintain a desirable value of the particle metric. For this purpose, a proportional-integral-differential (PID) algorithm can be used.

1. A coating device for coating a plurality of food pieces with a powdered material, comprising:
a. a permeable conveyor for transporting the plurality of food pieces;
b. a powdered material supply unit positioned directly above the permeable conveyor for depositing the powdered material onto the plurality of food pieces;
c. an air supply unit for directing a stream of air towards the plurality of food pieces, comprising:
i. a duct,
ii. a flow conditioner positioned inside the duct,
iii. a fan positioned upstream of the flow conditioner for generating the stream of air.

2. The coating device of claim 1, wherein the air supply unit is positioned below the permeable conveyor.

3. The coating device of claim 2, wherein the fan is an axial fan.

4. The coating device of claim 1, wherein the flow conditioner comprises a plurality of tubes parallel to each other and parallel to the stream of air.

5. The coating device of claim 1, wherein the powdered material is a seasoning.

6. The coating device of claim 1, further comprising:
a. a particle detector;
b. a light source;
c. a control unit for controlling a speed of the fan using a signal from the particle
detector.

7. The coating device of claim 6, wherein the particle detector is a digital camera.

8. A coating device for coating a plurality of food pieces with a powdered material, comprising:
a. a permeable conveyor for transporting the plurality of food pieces;
b. a powdered material supply unit positioned directly above the permeable conveyor for depositing the powdered material onto the plurality of food pieces;
c. an air supply unit positioned below the permeable conveyor for directing a stream of air towards the plurality of food pieces, comprising:
i. a duct,
ii. a flow conditioner positioned inside the duct, the flow conditioner comprising a plurality of tubes parallel to each other and parallel to the stream of air,
iii. a fan positioned upstream of the flow conditioner for generating the stream of air;
d. a digital camera;
e. a light source;
f. a control unit for controlling a speed of the fan using a signal from the digital camera.

9. The coating device of claim 8, wherein the fan is an axial fan.

10. The coating device of claim 8, wherein the powdered material is a seasoning.

11. The coating device of claim 8, wherein the digital camera and the light source are positioned in front of each other.

12. The coating device of claim 8, wherein the digital camera and the light source are positioned at an angle from each other.

13. A method for coating a plurality of food pieces with a powdered material using a coating device, the coating device comprising a permeable conveyor; a powdered material supply unit positioned directly above the permeable conveyor; an air supply unit positioned below the permeable conveyor, the air supply unit comprising a duct, a flow conditioner positioned inside the duct, and a fan positioned upstream of the flow conditioner; a particle detector; a light source; a control unit; the method comprising:
a. transporting the plurality of food pieces in the permeable conveyor;
b. depositing the powdered material onto the plurality of food pieces with the powdered material supply unit;
c. directing a stream of air towards the food pieces with the air supply unit, wherein the stream of air is generated with the fan;
d. directing a light from the light source towards the powdered material so that a fraction of the light reaches the particle detector;
e. receiving a desired range of values of a particle metric;
f. receiving a signal from the particle detector;
g. estimating a particle metric value using the signal from the particle detector;
h. varying a speed of the fan with the control unit using the desired range of values of the particle metric, and the estimated particle metric value using the signal from the particle detector.

14. The method in claim 13, wherein the particle metric value is a center of mass of an image detected with the particle detector.

15. The method in claim 13, wherein the particle detector and the light source are positioned in front of each other.

16. The method in claim 13, wherein the particle detector and the light source are positioned at an angle from each other.
